(19) United States
(12) Patent Application Publication
(10) Pub. No.: US 2025/0378451 A1
(43) Pub. Date: Dec. 11, 2025

(54) METHOD AND SYSTEM FOR DELIVERING CARBON NEUTRAL GAS AND VERIFYING ENVIRONMENTAL PARAMETERS OF SAME

(71) Applicant: BKV Corporation, Denver, CO (US)

(72) Inventors: Aseem Uday Telang, Arvada, CO (US); Joshua Robert Carlisle, Denver, CO (US); Samid Ameer Hoda, Thornton, CO (US)

(21) Appl. No.: 19/088,467

(22) Filed: Mar. 24, 2025

Related U.S. Application Data
(60) Provisional application No. 63/657,395, filed on Jun. 7, 2024.
(60) Provisional application No. 63/725,751, filed on Nov. 27, 2024.

(51) Int. Cl. G06Q 30/018; E21B 41/00; G06Q 20/36; G06Q 50/06

(52) U.S. Cl. CPC G06Q 30/018; E21B 41/0064; G06Q 20/36; G06Q 50/06

(57) ABSTRACT

Systems for delivering carbon neutral natural gas include an injection system positioned at an underground injection control well and configured to receive the measured amount of carbon dioxide (CO₂) generated by the first industrial process and inject the measured amount of CO₂ into a geologic formation via the well. The system will calculate a carbon offset amount that is a function of an amount of carbon credits and/or renewable energy credits associated with the CO₂. After receiving a request to deliver an amount of natural gas to a destination facility, the system will generate one or more digital tokens for each unit of measure of the amount, where the tokens include an identifier for the carbon offset amount, a confirmation of requirement of the carbon credits and a unique ID. The system will transfer the digital tokens to a digital wallet that is associated with the destination facility.

### RELATED APPLICATIONS AND CLAIM OF PRIORITY

This patent document claims priority to (a) U.S. Provisional Patent Application No. 63/657,395, filed Jun. 7, 2024; and (b) U.S. Provisional Patent Application No. 63/725,751, filed Nov. 26, 2024. The disclosure of each priority application is fully incorporated into this document by reference.

### BACKGROUND

The reduction of total carbon emissions from industrial operations, commercial facilities and individual homes and vehicles is a major goal in sustaining and improving the global environment. As part of this, many entities have a goal of decarbonization and, where possible, achieving carbon neutrality in their operations.

Working toward this goal, many operations have turned to natural gas as a replacement for traditional fuel sources such as oil or coal. Burning natural gas for energy results in fewer emissions of nearly all types of air pollutants and carbon dioxide (CO₂) emissions than burning coal or petroleum products to produce an equal amount of energy. However, emissions of CO₂ from the use of natural gas are still greater than zero.

Because an absolute zero emissions result is not always possible, some operations seek to achieve “carbon neutral” operations, in which they offset emissions from their energy consumption with credits for certified emission reductions or carbon removal carried out by others. However, the process by which natural gas consumers must either generate or procure emissions can be daunting. Many gas consumers lack the processing equipment and manpower required to generate offsets in other aspects of their operations. In addition, the process of procuring offsets does not always provide transparency into whether the operation that generated the offset otherwise operates in a sustainable manner.

Because of this, methods and systems for delivering sustainably sourced gas, and for verifying various environmental parameters of that gas, are needed. This patent document describes methods and systems that are directed to addressing these and/or additional issues.

### SUMMARY

In some aspects, the methods, systems, and devices described in this document relate to a system for delivering carbon neutral natural gas, in which the system includes: an injection system configured to receive a measured amount of carbon dioxide (CO₂) generated by a first industrial process and inject the measured amount of CO₂ into a geologic formation via an underground injection control (UIC) well to sequester the CO₂ as sequestered CO₂; and a computer processor. The system also includes a first set of programming instructions that are configured to instruct the processor to calculate a carbon offset amount that is a function of a number of carbon credits issued by a third-party registrar for the sequestered CO₂. The system also includes a second set of programming instructions that are configured to instruct the processor to, following a request to transfer a volume of natural gas to a destination facility: for each unit of measure of the volume, generate a digital token that includes an identifier for the carbon offset amount, a confirmation of retirement of the carbon credits, and a unique identifier for the digital token, and transfer the digital tokens to a digital wallet that is associated with the destination facility.

In some aspects, the methods, systems, and devices described in this document relate to a method of delivering carbon neutral natural gas, in which the method includes, by an injection system, receiving a measured amount of CO₂ generated by a first industrial process and injecting the measured amount of CO₂ into a geologic formation via a UIC well to sequester the CO₂ as sequestered CO₂. The method also includes, by a computer processor, executing programming instructions that cause the processor to calculate a carbon offset amount that is a function of a number of carbon credits issued by a third-party registrar for the sequestered CO₂. The method also includes, by the processor following a request to transfer a volume of natural gas to a destination facility: for each unit of measure of the volume, (a) generating a digital token that includes an identifier for the carbon offset amount, a confirmation of retirement of the carbon credits, and a unique ID for the digital token, and (b) transferring the digital tokens to a digital wallet that is associated with the destination facility.

### BRIEF DESCRIPTION OF THE DRAWINGS

FIG. 1 is a block diagram illustrating several elements of a system for delivering carbon neutral gas and verifying environmental parameters of the gas.

FIG. 2 is a flow diagram illustrating certain aspects of a method for delivering carbon neutral gas and verifying environmental parameters of same.

FIG. 3 is a flow diagram illustrating additional aspects of a method for delivering carbon neutral gas and verifying environmental parameters of same.

FIG. 4 illustrates information that may be included in an example credit retirement certificate.

FIG. 5 illustrates components of a computing device that may include a processor and programming instructions for executing various steps of the methods of FIGS. 2 and 3.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such as “first” and “second” are used to modify a noun, such use is simply intended to distinguish one item from another and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

Additional terms that are relevant to this disclosure will be defined at the end of this Detailed Description section.

As generally known in industry, and as described in United States Environmental Protection Agency guidance, “Scope 1 emissions” of an entity are direct greenhouse gas emissions that occur from sources that are controlled or owned by the entity, such as emissions associated with fuel combustion in boilers, furnaces, or vehicles. “Scope 2 emissions” of an entity are greenhouse gas emissions that the entity indirectly causes, and which are associated with the entity's purchase of energy such as electricity, steam, heat, or cooling. “Scope 3 emissions” of an entity are other greenhouse gas emissions that the entity indirectly causes through actions of others (such as suppliers) in the entity's value chain. General example sources of Scope 3 emissions include those associated with purchased goods and services, end use of product, transportation and distribution of products, waste, business travel, employee commuting, leased assets, and the like. For example, in the natural gas field, material Scope 3 emissions may include those associated with transmission, distribution, and end use of product.

This document describes methods and systems for delivering carbon neutral gas and verifying environmental parameters of such gas. The systems involve the capture of carbon dioxide (CO₂) and/or CO₂-equivalent (CO₂e) emissions and the processing of such emissions for reuse or permanent storage in subsurface geological formations. Such formations are used in conjunction with underground injection control (UIC) wells, and the process of injecting gas into geologic formations via such wells is known as sequestration. The process involves capturing CO₂ or another greenhouse gas (GHG) from a process before it is released into the atmosphere and then compressing the captured gas and transporting it (such as via pipeline) to a site where the gas can be injected into UIC wells for secure geologic sequestration. In the methods described in this document, GHG emissions that are sequestered are permanently stored, and the amount of gas sequestered can be verified by pre-and/or post-injection monitoring systems.

This document also describes methods and systems for verifying that use of natural gas in an operation achieves carbon neutral Scope 1, Scope 2, and/or Scope 3 emissions. To achieve a carbon neutral goal, the system may apply credits derived from CO₂ emissions that are sequestered to offset the CO₂ and/or CO₂e from GHG emissions from other operations that use natural gas. Although the terms “carbon neutrality” and “carbon neutral” terms are used in this document, the amount of emissions does not necessarily need to precisely equal the offsets. For purposes of this document, carbon neutrality may be achieved if substantially all emissions are offset, such as 95%, 96%, 97%, 98%, 99%, 99.9%, 100% or any fractional number in between any of these values, of the emissions. In addition, if more offsets than emissions are considered, the balance may be considered to carbon neutral.

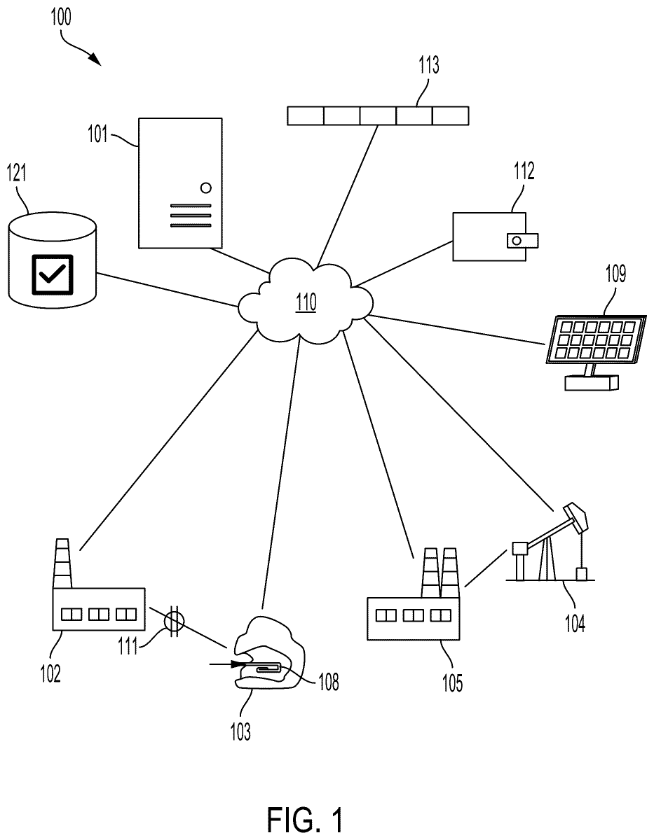

FIG. 1 is a block diagram that illustrates example elements of a system 100 for delivering carbon neutral natural gas. The system 100 includes a server 101 that includes a processor and a memory containing programming instructions that are configured to cause the processor to implement certain functions as will be described below. The server 101 is in communication with other elements of the system via a communication network 110.

A first industrial process 102 is located at a first industrial facility and generates CO₂ emissions that are part of the process. The first industrial process 102 may be any type of process that generates CO₂ emissions, such as a power generation facility, a manufacturing facility, or a chemical production facility. Although this example refers to CO₂ emissions, the systems and methods described in this document could also be used for any GHG such as methane (CH₄), nitrous oxide (N₂O), hydrofluorocarbons (HFCs), perfluorocarbons (PFCs), nitrogen trifluoride (NF₃), and sulfur hexafluoride (SF₆), which are sometimes known as CO₂e gases. Thus, unless specifically noted, when the examples refer to CO₂, they are intended to refer to CO₂ or any CO₂e gas. In addition, when the figures, claims, and description use the term “GHG” the intent is to include embodiments where the GHG is a single GHG (such as CO₂), as well as embodiments where the GHG is multiple GHGs (such as CO₂ plus a CO₂e gas).

An injection system 108 is positioned at an underground injection control (UIC) well 103 and is configured to receive the CO₂ generated by the first industrial process 102 and inject the CO₂ into the UIC well 103 to sequester the CO₂ in a geologic formation at which the UIC well 103 is located. (This document may refer to the CO₂ or other GHG held in the formation as “sequestered CO2” or “sequestered GHG”.) A gas sensor such as a CO₂ sensor, monitor, or chromatograph 111 is configured to measure the amount of CO₂ generated by the first industrial process that is sequestered via the well into the geologic formation 103. The sensor 111 may be located at the industrial facility 102, at the injection system 108 or UIC well 103, or any location in between.

The server 101 includes programming instructions that are configured to instruct the processor to calculate a carbon offset amount that is a function of the amount of CO₂ that has been sequestered and verified as carbon credits by a third-party registrar 121. The third-party registrar 121 may be a government agency such as the California Air Resources Board, an entity that is accredited by a government agency, or an independent organization such as the ACR or Climate Action Reserve. Optionally, the carbon offset amount may be a function of both the amount of sequestered CO₂ and an amount of renewable energy credits (RECs) associated with an amount of electricity generated by a renewable energy resource 109 such as solar panels and a solar power generation facility, wind turbines and a wind power generation facility, and/or hydroelectric power plant. The renewable energy resource may be owned, controlled or operated by a natural gas provider 104 that will deliver the amount of natural gas to a destination facility 105. Alternatively, the renewable energy resource may be a third-party resource, and the natural gas provider may acquire the RECs from the renewable energy resource or an intermediary.

The system 100 also includes or is able to communicate with a digital wallet 112, distributed digital ledger 113 (i.e., a blockchain), and/or other secure data storage systems. Details of how such items are used will be described in more detail below.

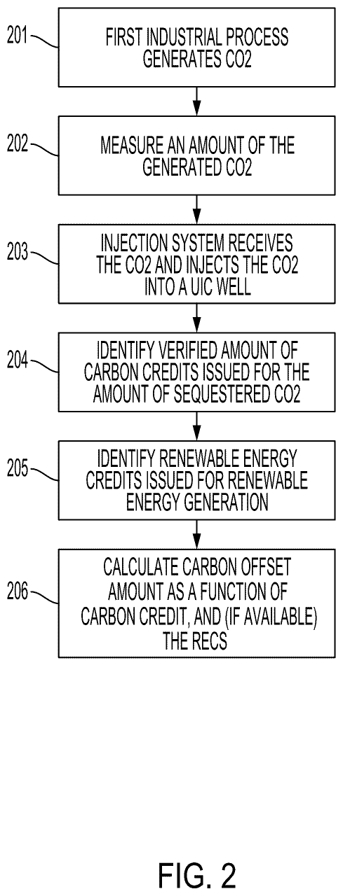

FIG. 2 is a flow diagram illustrating certain actions that the system may implement to verify that certain credits generated by or otherwise available to the first industrial process 101 can be verified, transferred to a destination facility (105 in FIG. 1) and retired to prevent the use of any single credit multiple times. After the first industrial process generates CO₂ emissions (step 201) the CO₂ will be captured and transferred to a UIC well injection system (step 203) that will sequester the CO₂ in a geologic formation. At step 202 a sensor located at the industrial process facility, in the injection system, at the well, or at any point between these elements will measure the amount of the first industrial process's CO₂ that is injected in the well and thus sequestered in the geologic formation.

At 204 the processor will verify whether a third-party registrar has issued carbon credits for the amount of sequestered CO₂. Optionally, at 205 the processor may verify whether the first industrial process is entitled to renewable energy credits (RECs) for other activities in which a renewable energy resource generates electricity, such as solar power generation or wind power generation. The renewable energy resource may be one associated with the first industrial process, or it may be a third party resource with RECs available to transfer. The processor may perform this verification by a query or API call to the third-party registrar or issuer, or by another process such as a query or API to a trusted, independent third-party service provider. In either step 204 or 205, if verified, the third-party registrar or issuer may provide the processor with a unique identifier for the carbon credits or RECs.

At 206 the processor will calculate a carbon offset amount that is a function of the number of verified carbon credits issued by the third-party registrar. If RECs are also being considered, the carbon offset calculation will also be a function of the amount of RECs associated with the amount of electricity generated by the renewable energy resource. The function may simply be a sum of these amounts, a weighted sum, or some other function that also considers other parameters. For example, the processor may monitor operational parameters of both the injection system and the first industrial facility, and the processor may calculate the carbon offset amount as a sum of: (a) the amount of CO₂ sequestered in the UIC well and verified as carbon credits by the third party registrar; and (b) the amount of RECs associated with the amount of electricity generated by the renewable energy resource. The system may store information relating to the carbon offset amount, along with information used to calculate it, as one or more records in a data store.

Returning to FIG. 1, the server 101 also may be in communication with one or more natural gas production or distribution facilities 104 that produce and/or distribute natural gas to any number of end users. The natural gas distributed to a destination facility may be in its standard form (i.e., in the form of an uncompressed gas, but after processing to remove water vapor, various natural gas plant liquids, and other compounds), or the natural gas may be in the form of liquefied natural gas (LNG), compressed natural gas (CNG), or another processed form.

When a destination facility 105 desires to receive and use the natural gas and be able to certify that its use of the natural gas will be carbon neutral, the server 101 may implement methods that provide a destination facility 105 the ability to verify that gas that it receives and uses can be verified as carbon neutral. In various embodiments, the first industrial process 102 and the destination facility 105 are located at the same industrial facility. Alternatively, the first industrial process 102 and the destination facility 105 may be located at different industrial facilities. The server 101 may be located at the first industrial facility that includes the first industrial process 102, the destination facility 105, the natural gas provider facility 104, another facility, or a combination of these. In addition, the server may be a distributed system comprising multiple processors located at multiple facilities.

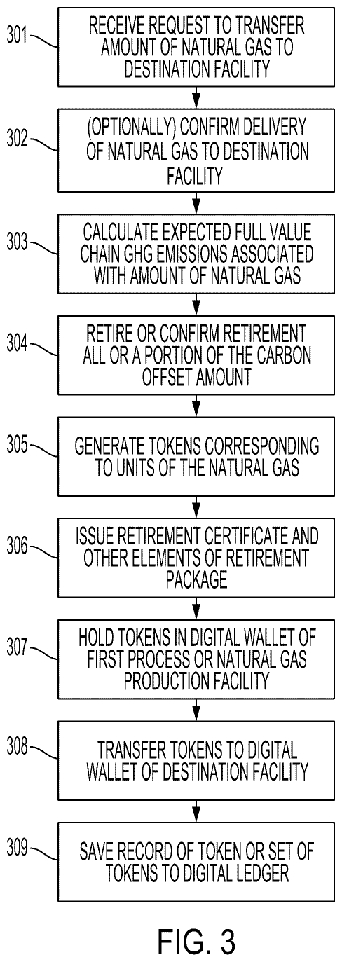

Referring to FIG. 3, in some embodiments, after the processor receives a request to deliver, send, or otherwise transfer an amount of natural gas to a destination facility that will use the natural gas in an industrial process (step 301), and optionally also after confirming that the natural gas has been or will be transferred to the destination facility (step 302), the system will calculate an amount of expected CO₂ and/or CO₂e from GHG emissions associated with the amount of natural gas for the destination facility (step 303).

The methods by which the system calculates expected emissions may depend on the point of view considered by the calculation. For example, from the point of view of the natural gas provider, calculating the amount of expected CO₂ and/or CO₂e emissions at step 303 may include: (a) calculating a first value associated with an amount of potential CO₂ and/or CO₂e from use or other processing of the amount of natural gas by the second industrial process (i.e., Scope 1 emissions); (b) calculating a second value associated with an amount of CO₂ and/or CO₂e from generation of the electricity used by the natural gas provider in producing the amount of natural gas (i.e., Scope 2 emissions); (c) calculating a third value associated with an amount of CO₂ and/or CO₂e emissions that the second industrial process indirectly causes by the natural gas provider having produced the amount of natural gas (i.e., Scope 3 emissions); and (d) generating a sum that includes the first amount, the second amount, and/or the third amount.

As an alternative option, and form the point of view of the end user of the natural gas, calculating the amount of expected CO₂ and/or CO₂e at step 303 may comprise: (a) calculating a first value associated with an amount of potential CO₂ and/or CO₂e from producing the amount of natural gas by the natural gas provider (i.e., Scope 1 emissions); (b) calculating a second value associated with an amount of CO₂ and/or CO₂e from generation of electricity used by the natural gas provider in producing the amount of natural gas (i.e., Scope 2 emissions); (c) calculating a third value associated with use of the amount of natural gas by the destination facility (i.e., additional Scope 1 emissions and/or scope 3); and (d) generating a sum that includes the first amount, the second amount, and/or the third amount.

At 304, the system will confirm that carbon credits (and optionally also RECs) associated with the carbon offset amount are being retired or have been retired in connection with the delivery of natural gas to the destination facility. The system may obtain this confirmation by submitting a request to a third-party registrar 121 by an electronic message, application programming interface (API) call, or other communication, and receiving a response confirming that the credits are retired. The response may include one or more unique identifiers issued by the registrar for each of the credits or for a bundle of the credits. Alternatively, if the system is affiliated with the registrar, then the system may perform the retirement itself at 304.

At 305 the system will generate one or more digital tokens, each of which will correspond to a single unit of measure (such as a single MMBtu) of the natural gas that is, will be, or has been transferred to the destination facility. Each digital token will include various data, including at a minimum a value or identifier for all or a portion of the carbon offset amount, a confirmation of retirement of the carbon credits or RECs, and a unique identifier for the token. Each digital token also may include other information, such as data that identifies the source of the operational parameters, or data that identifies the natural gas production facility, the UIC well, and/or the destination facility.

At 307 the system will save the one or more digital tokens to a first digital wallet or other data store that is associated with the natural gas provider or the first industrial process.

After confirming that the amount of natural gas is, will be, or has been transferred to the second industrial facility by a natural gas provider at 302, at 308 the system will transfer the selected set of the digital tokens from the first digital wallet or other data store to a second digital wallet or other data store that is associated with the second industrial facility.

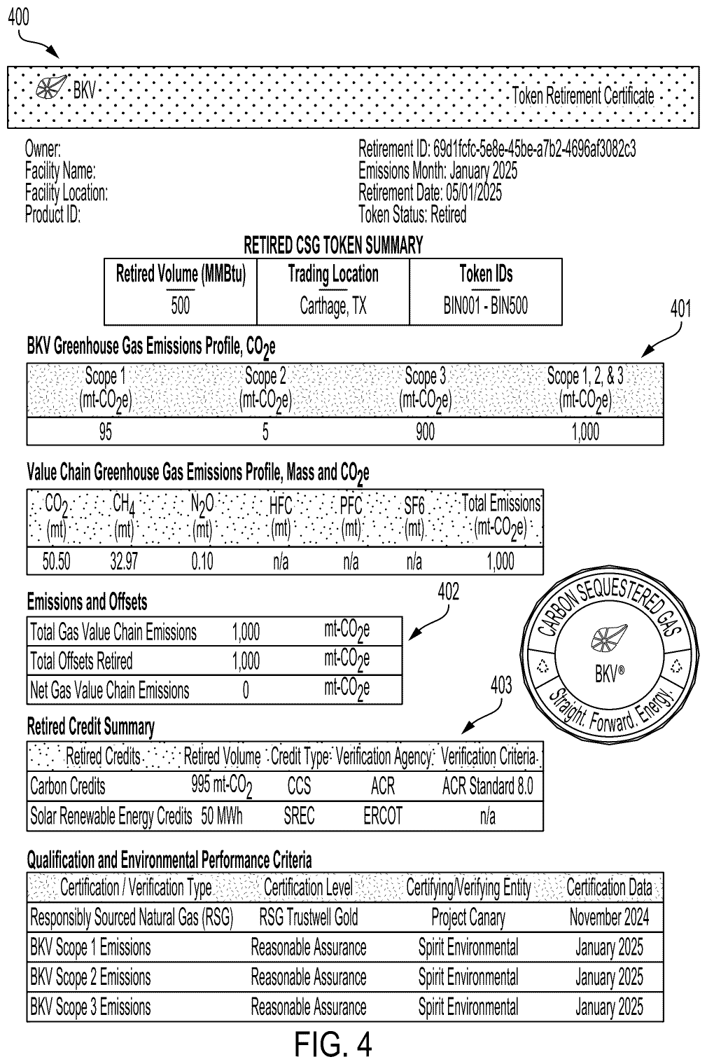

Optionally, the method may include (at step 306) generating a retirement certificate comprising at least the number of the carbon credits, RECs, or both that are being retired and including the retirement certificate or information from the retirement certificate in one or more of the digital tokens. Information that may be included in an example retirement certificate 400 is illustrated in FIG. 4. The retirement certificate may include GHG attributes 401, emissions performance data 402, third party verified and/or third party issued carbon credits and/or RECs 403, a credit certification number or range of numbers, and/or other information.

Optionally, the retirement certificate and/or other documentation associated with the transaction may be bundled into a single file or a data set, and the system may create a hash of the bundle. The bundle, the hash, or both may be included in the digital token at step 305.

Optionally, at 309 the method may include, after or in connection with transferring the digital tokens to the second digital wallet, saving a record of the transfer of one or more of the digital tokens to a distributed digital ledger (e.g., a blockchain). The distributed ledger may be a public blockchain, a private blockchain, a permissioned blockchain, or a hybrid blockchain. If a hash of the bundled documents or of the record has been created, the bundle and/or hash also may be saved to a distributed digital ledger. For example, the record may be a single ledger record identifying a set of the digital tokens associated with a natural gas delivery transaction, and/or some or all data from that set of digital tokens.

The steps of FIGS. 2 and 3 described above do not necessarily need to be performed in sequence. Various steps may be performed in parallel rather than in sequence. In addition, the order of any steps may be inverted unless the context specifically requires otherwise (such as by a later step requiring information from an earlier step).

The creation of digital tokens with information described in this document can ensure that double-counting of emission offsets and/or carbon credits is avoided. For example, if the system later receives a request to use one or more of the carbon credits associated with one or more of the digital tokens, the system can use the record to confirm that the credits have been already retired and thus not approve the request to use those carbon credits again. Instead, the system may issue, to the entity that made the request, a retirement certificate, assurance certificate, or both that includes a number of retired carbon credits associated with the digital token. The assurance certificate will be issued by the third party that has reviewed the calculations and credit retirement volumes. The retirement certificate will represent the retirement of the credits.

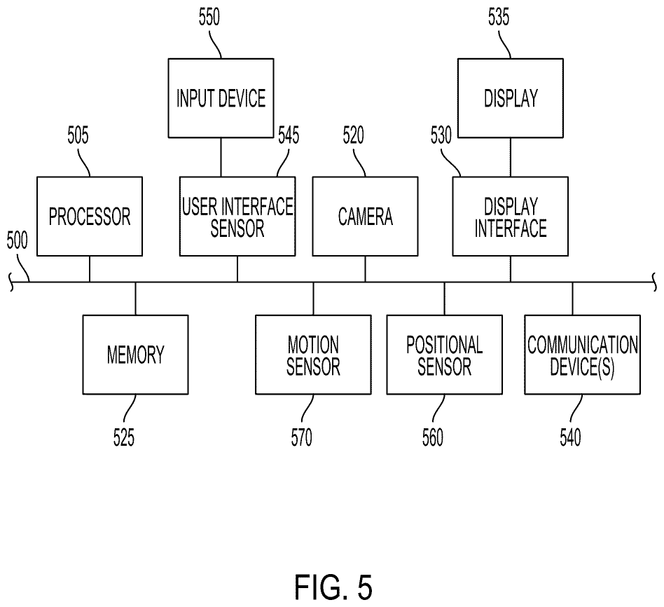

FIG. 5 depicts an example of internal hardware that may be included in any of the electronic components of the system, such as the user's smartphone or a local or remote computing device in the system. An electrical bus 500 serves as a communication path via which messages, instructions, data, or other information may be shared among the other illustrated components of the hardware. Processor 505 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 525. A memory device may include a single device or a collection of devices across which data and/or instructions are stored.

An optional display interface 530 may permit information to be displayed on a display device 535 in visual, graphic or alphanumeric format. An audio interface and audio output (such as a speaker) also may be provided. Communication with external devices may occur using various communication devices 540 such as a wireless antenna, a radio frequency identification (RFID) tag and/or short-range or near-field communication transceiver, each of which may optionally communicatively connect with other components of the device via one or more communication systems. The communication device 540 may be configured to be communicatively connected to a communications network, such as the Internet, a local area network or a cellular telephone data network.

The hardware may also include a user interface sensor 545 that allows for receipt of data from input devices 550 such as a keyboard, a mouse, a touchscreen, a touch pad, a remote control, a pointing device and/or microphone. Digital image frames also may be received from a camera 520 that can capture video and/or still images. The system also may include a positional sensor 560 and/or motion sensor 570 to detect position and movement of the device. Examples of motion sensors 570 include gyroscopes or accelerometers. Examples of positional sensors 560 include a global positioning system (GPS) sensor device that receives positional data from an external GPS network.

Terminology that is relevant to this disclosure includes:

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 5.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

The features and functions described above, as well as alternatives, may be combined into many other different systems or applications. Various alternatives, modifications, variations or improvements may be made by those skilled in the art, each of which is also intended to be encompassed by the disclosed embodiments.

As described above, this document discloses system, method, and computer program product embodiments for implementing a hybrid spreadsheet and coding environments. The system embodiments include a local computing device, which may have access to one or more remote computing devices. In some embodiments, one or more of the remote computing devices also may be part of the system. The computer program embodiments include programming instructions, stored in a memory device, that are configured to cause a processor to perform the methods described in this document.

Various aspects of the disclosure may be represented by the following clauses:

Clause 1. A system for delivering carbon neutral natural gas comprises an injection system configured to receive a measured amount of carbon dioxide (CO₂) generated by a first industrial process and inject the measured amount of CO₂ into a geologic formation via an underground injection control well to sequester the CO₂ as sequestered CO₂. The system also includes a computer processor and a first set of programming instructions that are configured to instruct the processor to calculate a carbon offset amount that is a function of a number of carbon credits issued by a third-party registrar for the sequestered CO₂. The system also includes a second set of programming instructions that are configured to instruct the processor to, following a request to transfer a volume of natural gas to a destination facility: (a) for each unit of measure of the volume, generate a digital token that includes an identifier for the carbon offset amount, a confirmation of retirement of the carbon credits, and a unique identifier for the digital token, and ((b) transfer the digital tokens to a digital wallet that is associated with the destination facility.

Clause 2. The system of clause 1, wherein the second set of programming instructions further comprise instructions to: generate a record that associates all of the digital tokens with the volume of natural gas and the destination facility; generate a unique identifier for the record; and save the record and unique identifier to a distributed digital ledger or a data store.

Clause 3. The system of clause 1 or 2, wherein the second set of programming instructions further comprises instructions to, before transferring the digital tokens to the digital wallet that is associated with the destination facility: (a) save the digital tokens to a digital wallet that is associated with a natural gas provider, and (b) verify that the volume of natural gas is or will be transferred to the destination facility, wherein the instructions to transfer the digital tokens to the digital wallet that is associated with the destination facility comprise instructions to transfer the digital tokens from the digital wallet associated with the natural gas provider to the digital wallet associated with the destination facility.

Clause 4. The system of any of clauses 1-3, wherein the instructions to generate the digital tokens comprise instructions to: calculate an amount of expected CO₂ and/or CO₂e from greenhouse gas emissions by the destination facility associated with the volume of natural gas; and associate an amount of the carbon credits with the digital tokens that corresponds to the amount of expected CO₂ and/or CO₂e.

Clause 5. The system of clause 4, wherein the instructions to calculate the amount of expected CO₂ and/or CO₂e comprise instructions to: calculate a first value associated with potential CO₂ and/or CO₂e from use or other processing of the volume of natural gas by the destination facility; calculate a second value associated with CO₂ and/or CO₂e from generation of electricity used by a natural gas provider in producing the amount of natural gas; calculate a third value associated with CO₂ and/or CO₂e that the destination facility will indirectly cause by the natural gas provider having produced the amount of natural gas; and generate a sum that includes the first value, the second value, and the third value.

Clause 6. The system of clause 4, wherein the instructions to calculate the amount of expected CO₂ and/or CO₂e comprise instructions to: calculate a first value associated with potential CO₂ and/or CO₂e from producing the amount of natural gas; calculate a second value associated with CO₂ and/or CO₂e from generation of electricity used by a natural gas provider in producing the amount of natural gas; calculate a third value associated with use of the volume of natural gas by the destination facility; and generate a sum that includes the first value, the second value, and the third value.

Clause 7. The system of any of clauses 1-6, wherein each of the digital tokens also comprises: identifying information for a source of data used to calculate the carbon offset amount; and identifying information for the destination facility.

Clause 8. The system of any of clauses 1-7, wherein the first set of programming instructions are further configured to instruct the processor to monitor operational parameters of both the injection system and the first industrial process, and the second set of programming instructions are further configured to instruct the processor to include one or more of the operational parameters in the digital tokens.

Clause 9. The system of any of clauses 1-8, further comprising additional programming instructions that are configured to cause the processor to: generate a retirement certificate comprising at least the number of the carbon credits; and include the retirement certificate or information from the retirement certificate in one or more of the digital tokens.

Clause 10. The system of any of clauses 1-9, further comprising additional programming instructions that are configured to cause the processor to, in response to transferring the digital tokens to the digital wallet, save a record of the transfer to a distributed digital ledger or a data store.

Clause 11. The system of any of clauses 1-10, further comprising additional programming instructions that are configured to cause the processor to, in response to receiving and approving a request to use one or more of the carbon credits associated with one or more of the digital tokens, issue, to an entity that made the request, an assurance certificate, a retirement certificate, or both for a value equal to all or a portion of the number of carbon credits associated with the one or more digital tokens.

Clause 12. The system of any of clauses 1-11, wherein the instructions to calculate the carbon offset amount comprise instructions to do so as a function of both the number of carbon credits and an amount of renewable energy credits (RECs) associated with an amount of electricity generated by a renewable energy resource.

Clause 13. The system of clause 12, wherein the renewable energy resource comprises a solar panel system, and the RECs comprise solar renewable energy credits.

Clause 14. The system of clause 12, wherein the renewable energy resource is owned, controlled or operated by a natural gas provider that will deliver the volume of natural gas to the destination facility.

Clause 15. The system of any of clauses 1-14, wherein the first industrial process is located at the destination facility, or the first industrial process is located at a facility other than the destination facility.

Clause 16. The system of any clauses 1-15, further comprising a gas sensor configured to measure the amount of CO₂ injected into the geologic formation via the underground injection control well.

Clause 17. A method of delivering carbon neutral natural gas, in which the method comprises, by an injection system, receiving a measured amount of CO₂ generated by a first industrial process and injecting the measured amount of CO₂ into a geologic formation via an underground injection control well to sequester the CO₂ as sequestered CO₂. The method also includes, by a computer processor, executing programming instructions that cause the processor to: calculate a carbon offset amount that is a function of a number of carbon credits issued by a third-party registrar for the sequestered CO₂, and following a request to transfer a volume of natural gas to a destination facility: (a) for each unit of measure of the volume, generating a digital token that includes an identifier for the carbon offset amount, a confirmation of retirement of the carbon credits, and a unique identifier for the digital token, and (b) transferring the digital tokens to a digital wallet that is associated with the destination facility.

Clause 18. The method of clause 17, further comprising the elements of any of clauses 2-16.

1. A system for delivering carbon neutral natural gas, the system comprising:
an injection system that, in operation, will receive a measured and compressed amount of carbon dioxide (CO₂) generated by a first industrial process and inject the measured and compressed amount of CO₂ into a geologic formation via an underground injection control (UIC) well to sequester the CO₂ as sequestered CO₂;
a computer processor; and
a computer-readable medium having a first set of programming instructions stored thereon which, when executed by the processor, will cause the processor to:
calculate a carbon offset amount that is a function of a number of carbon credits issued by a third-party registrar for the sequestered CO₂; and
a second set of programming instructions that are configured to instruct the processor to, following a request to transfer a volume of natural gas to a destination facility:
for each unit of measure of the volume, generate a digital token that includes an identifier for the carbon offset amount, a confirmation of retirement of the carbon credits, and a unique ID for the digital token, and
transfer the digital tokens to a digital wallet that is associated with the destination facility.

2. The system of claim 1, wherein the second set of programming instructions further comprise instructions to:
generate a record that associates all of the digital tokens with the volume of natural gas and the destination facility;
generate a unique identifier for the record; and
save the record and unique identifier to a distributed digital ledger or a data store.

3. The system of claim 1, wherein the second set of programming instructions further comprises instructions to:
before transferring the digital tokens to the digital wallet that is associated with the destination facility:
save the digital tokens to a digital wallet that is associated with a natural gas provider, and
verify that the volume of natural gas is or will be transferred to the destination facility,
wherein the instructions to transfer the digital tokens to the digital wallet that is associated with the destination facility comprise instructions to transfer the digital tokens from the digital wallet associated with the natural gas provider to the digital wallet associated with the destination facility.

4. The system of claim 1, wherein the instructions to generate the digital tokens comprise instructions to:
calculate an amount of expected CO₂ and/or CO₂e from GHG emissions by the destination facility associated with the volume of natural gas; and
associate an amount of the carbon credits with the digital tokens that corresponds to the amount of expected CO₂ and/or CO₂e.

5. The system of claim 4, wherein the instructions to calculate the amount of expected CO₂ and/or CO₂e comprise instructions to:
calculate a first value associated with potential CO₂ and/or CO₂e from use or other processing of the volume of natural gas by the destination facility;
calculate a second value associated with CO₂ and/or CO₂e from generation of the electricity used by a natural gas provider in producing the amount of natural gas;
calculate a third value associated with CO₂ and/or CO₂e that the destination facility will indirectly cause by the natural gas provider having produced the amount of natural gas; and
generate a sum that includes the first value, the second value, and the third value.

6. The system of claim 4, wherein the instructions to calculate the amount of expected CO₂ and/or CO₂e comprise instructions to:
calculate a first value associated with potential CO₂ and/or CO₂e from producing the amount of natural gas;
calculate a second value associated with CO₂ and/or CO₂e from generation of electricity used by a natural gas provider in producing the amount of natural gas;
calculate a third value associated with use of the volume of natural gas by the destination facility; and
generate a sum that includes the first value, the second value, and the third value.

7. The system of claim 1, wherein each of the digital tokens also comprises:
identifying information for a source of data used to calculate the carbon offset amount; and
identifying information for the destination facility.

8. The system of claim 1, wherein:
the first set of programming instructions also will, when executed by the processor, instruct the processor to monitor operational parameters of both the injection system and the first industrial process; and
the second set of programming instructions also will, when executed by the processor, instruct the processor to include one or more of the operational parameters in the digital tokens.

9. The system of claim 1, further comprising additional programming instructions that will, when executed by the processor, cause the processor to:
generate a retirement certificate comprising at least the number of the carbon credits; and
include the retirement certificate or information from the retirement certificate in one or more of the digital tokens.

10. The system of claim 1, further comprising additional programming instructions that will, when executed by the processor, cause the processor to, in response to transferring the digital tokens to the digital wallet, save a record of the transfer to a distributed digital ledger or a data store.

11. The system of claim 1, further comprising additional programming instructions that will, when executed by the processor, cause the processor to, in response to receiving and approving a request to use one or more of the carbon credits associated with one or more of the digital tokens:
issue, to the entity that made the request, an assurance certificate, a retirement certificate, or both for a value equal to all or a portion of the number of carbon credits associated with the one or more digital tokens.

12. The system of claim 1, wherein the instructions to calculate the carbon offset amount comprise instructions to do so as a function of both the number of carbon credits and an amount of renewable energy credits (RECs) associated with an amount of electricity generated by a renewable energy resource.

13. The system of claim 12, wherein:
the renewable energy resource comprises a solar panel system; and
the RECs comprise solar renewable energy credits (SRECs).

14. The system of claim 12, wherein the renewable energy resource is owned, controlled or operated by a natural gas provider that will deliver the volume of natural gas to the destination facility.

15. The system of claim 1, wherein:
the first industrial process is located at the destination facility; or
the first industrial process is located at a facility other than the destination facility.

16. The system of claim 1, further comprising a gas sensor that will, in operation, measure the amount of CO₂ injected into the geologic formation via the UIC well.

17. A method of delivering carbon neutral natural gas, the method comprising:
by an injection system, receiving a compressed amount of carbon dioxide (CO₂) generated by a first industrial process and injecting the compressed amount of CO₂ into a geologic formation via an underground injection control well to sequester the CO₂ as sequestered CO₂; and
by a computer processor, executing programming instructions that cause the processor to:
calculating a carbon offset amount that is a function of a number of carbon credits issued by a third-party registrar for the sequestered CO₂, and
following a request to transfer a volume of natural gas to a destination facility:
for each unit of measure of the volume, generating a digital token that includes an identifier for the carbon offset amount, a confirmation of retirement of the carbon credits, and a unique identifier for the digital token, and
transferring the digital tokens to a digital wallet that is associated with the destination facility.

18. The method of claim 17 further comprising, by the computer processor:
generating a record that associates all of the digital tokens with the volume of natural gas and the destination facility;
generating a unique identifier for the record; and
saving the record and unique identifier to a distributed digital ledger or a data store.

19. The method of claim 17, further comprising, before transferring the digital tokens to the digital wallet that is associated with the destination facility:
saving the digital tokens to a digital wallet that is associated with a natural gas provider; and
verifying that the volume of natural gas is or will be transferred to the destination facility,
wherein transferring the digital tokens to the digital wallet that is associated with the destination facility comprises transferring the digital tokens from the digital wallet associated with the natural gas provider to the digital wallet associated with the destination facility.

20. The method of claim 17, wherein generating the digital tokens comprises:
calculating an amount of expected CO₂ and/or CO₂e from greenhouse gas emissions by the destination facility associated with the volume of natural gas; and
associating an amount of the carbon credits with the digital tokens that corresponds to the amount of expected CO₂ and/or CO₂e.

21. The method of claim 17, further comprising, by a gas sensor before the injection system injects the compressed amount of CO₂ into the geologic formation, measuring the compressed amount of CO₂.

22. The method of claim 17, further comprising, before the injection system injects the compressed amount of CO₂ into the geologic formation, compressing an amount of CO₂ generated by the first industrial process to yield the compressed amount of CO₂.
